(19) United States
(12) Patent Application Publication
(10) Pub. No.: US 2022/0201137 A1
(43) Pub. Date: Jun. 23, 2022

(54) IMAGE PROCESSING DEVICE AND INFORMATION PROCESSING DEVICE

(71) Applicant: FUJIFILM Business Innovation Corp., Tokyo (JP)

(72) Inventor: Yoko TSURUMI, Kanagawa (JP)

(73) Assignee: FUJIFILM Business Innovation Corp., Tokyo (JP)

(21) Appl. No.: 17/246,918

(22) Filed: May 3, 2021

(30) Foreign Application Priority Data
Dec. 23, 2020 (JP) 2020-213520

(51) Int. Cl. H04N 1/00

(52) U.S. Cl. CPC H04N 1/00472; H04N 2201/0094; H04N 1/00424; H04N 1/00411

(57) ABSTRACT

An image processing device includes: a notification unit configured to notify a user that it is forgotten to take a medium from the image processing device; and an output unit configured to, if (a)(i) it is forgotten to take the medium or (ii) there is a possibility that it i s forgotten to take the medium and (b) predetermined, another operation excluding an operation relating to removal of the medium is performed, output unchecked information that is a notification to the user indicating that there are contents to be newly checked.

### CROSS-REFERENCE TO RELATED APPLICATIONS

This application is based on and claims priority under 35 USC 119 from Japanese Patent Application No. 2020-213520 filed Dec. 23, 2020.

### BACKGROUND

### (i) Technical Field

The present disclosure relates to an image processing device and an information processing device.

### (ii) Related Art

JP-A-2007-324909 describes a method with which a device detects an original document left on the device. The method includes repeatedly detecting a human body during detection of the original document, and notifying, by causing a sounding body to ring, that the original document is left upon detecting that no human body exists near the device.

### SUMMARY

A user may forget to take a medium after an image processing device performs a process using a document table or after the image processing device performs a process of outputting the medium to a discharge tray. As a countermeasure, when there is a possibility that a medium is left on the document table or the discharge tray, a notification is given to the user.

However, even though there is a possibility that a medium is left on the document table or the discharge tray, such a notification indicating that it is forgotten to take the medium may not be given to the user if a particular process was performed.

Aspects of non-limiting embodiments of the present disclosure relate to reducing a chance that a user forgets to take a medium as compared with a case in which a notification indicating that it is forgotten to take a medium is not given if a particular process was performed even though there is a possibility that the medium is left on a document table or a discharge tray.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing device including: a notification unit configured to notify a user that it is forgotten to take a medium from the image processing device; and an output unit configured to, if (a)(i) it is forgotten to take the medium or (ii) there is a possibility that it is forgotten to take the medium and (b) predetermined, another operation excluding an operation relating to removal of the medium is performed, output unchecked information that is a notification to the user indicating that there are contents to be newly checked.

### BRIEF DESCRIPTION OF THE DRAWINGS

Exemplary embodiment(s) of the present disclosure will be described in detail based on the following figures, wherein:

FIG. 1 is a perspective view of an image processing device according to an exemplary embodiment;

FIG. 2 is a block diagram illustrating an example of a hardware configuration of the image processing device according to the exemplary embodiment;

FIG. 3 is a block diagram illustrating an example of a functional configuration of a controller;

FIG. 4 is a flowchart of a processing procedure for performing a notification or an output about forgetting to take an original document;

FIGS. 5A to 5C illustrate examples of an element added to an operation screen having a fixed screen and a menu screen; and

FIGS. 6A to 6C illustrate examples of an element added to an operation screen having no fixed screen.

### DETAILED DESCRIPTION

Hereinafter, an exemplary embodiment of the present disclosure will be described in detail with reference to the accompanying drawings.

### Appearance of Image Processing Device

First, an appearance of an image processing device 10 according to an exemplary embodiment will be described.

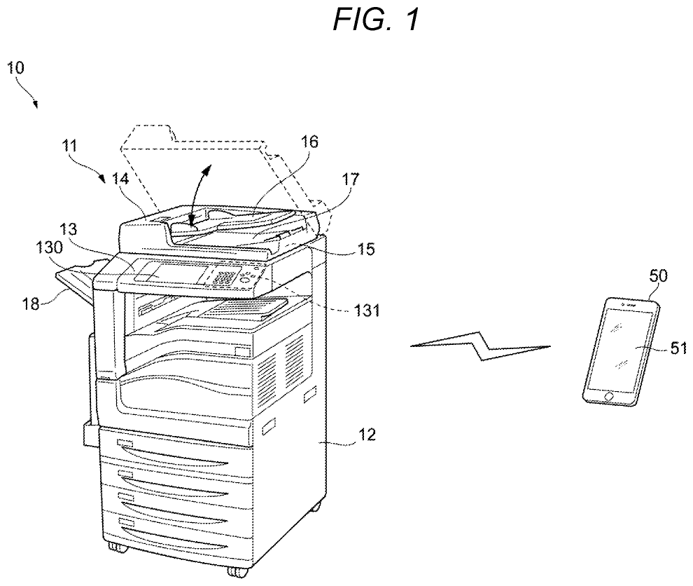

FIG. 1 is a perspective view of the image processing device 10 according to the present exemplary embodiment. The image processing device 10 according to the present exemplary embodiment is a so-called multifunction device having various image processing functions such as an image reading function (scanning function), a printing function, a copying function, and a facsimile function.

The image processing device 10 includes a scanner 11, a printer 12, and a user interface (UI) 13. Among them, the scanner 11 is a device that reads an image formed on a medium, and the printer 12 is a device that forms an image on a medium. The user Interface 13 is a device that receives an instruction inputs by a user when the user operates the image processing device 10, and that displays various information to the user. Together with or in place of the user interface 13, an external terminal device 50 may display information to the user and receive an operation performed by the user.

In the present disclosure, the term “medium” include an original document and a discharged product such as a printed product.

The scanner 11 of the present exemplary embodiment is disposed above the printer 12. Here, the scanner 11 includes a platen cover 14 and a document table 15 on which an original document is to be placed. The platen cover 14 can be opened and closed in up and down directions as indicated by arrows in FIG. 1. The document table 15 includes a transparent glass that is a so-called “platen glass”. The document table 15 transmits light from below, and transmits reflected light from the original document. When opening the platen cover 14 upwards, the user can place the original document on the document table 15. When the user closes the platen cover 14 downwards to return the platen cover 14 to its original position after the user has placed the original document on the document table 15, the platen cover 14 secures the original document placed on the document table 15. The original document placed on the document table 15 is irradiated with the light transmitted from below the document table 15, and a CCD or the like detects light which is reflected by the original document and passes through the document table 15, so that image information of the original document is read.

The platen cover 14 may simply include a lid body structure which is a so called “platen cover”. Alternatively, the platen cover 14 may include a document feeder 16 that feeds original documents to read the original documents as illustrated in FIG. 1. In an example in which the platen cover 14 includes the document feeder 16, the platen cover 14 also includes a document discharge unit 17 to which the original documents read by the scanner 11 are discharged. The image processing device 10 includes a discharge unit 18 that accommodates the discharged products, which are the printed products on each of which an image is formed by the printer 12. The term “discharge unit” in the present disclosure includes the discharge unit 18 and the document discharge unit 17.

The user interface 13 is disposed on a front side of the image processing device 10 (specifically, the scanner 11) so as to facilitate the user to operate the image processing device 10.

Here, the user interface 13 includes a display 130 and an operation receiving unit 131. The display 130 is used to display a screen for operation (that is, an operation screen). The operation receiving unit 131 receives an operation performed by the user. The user interface 13 functions as a so-called touch panel. The display 130 is implemented by, for example, a liquid crystal display panel or an organic electro luminance (EL) display panel. The display 130 displays the operation screen including at least one of (i) operation buttons to be operated by the user or (ii) management information on the image processing device 10. The operation receiving unit 131 is an input device that receives the operation performed by the user. The operation receiving unit 131 includes, for example, buttons, switches, and a touch panel.

In the present exemplary embodiment, the display 130 of the user Interface 13 is an example of an output unit that outputs unchecked information and checked information (which will be described later) and an example of a notification unit that notifies the user of forgetting to take a medium. Examples of the notification unit may include, in addition to the user interface 13, generation of warning sound by a not-illustrated sound body (such as a buzzer), and turning on of a not-illustrated warning lamp (such as an LED) that is provided on the user interface 13 or in the image processing device 10.

Furthermore, the image processing device 10 includes various sensors each of which detect forgetting to take the original document (an example of the medium) or the discharged product (another example of the medium). More specifically, although not illustrated, for example, a document detecting sensor, a detecting sensor that detects opening and closing of the platen cover 14, and a detecting sensor of the document discharge unit are provided on a body of the image processing device 10 and the scanner 11. The document detecting sensor reads the original document with the CCD which is used by the scanner 11, to detect the original document placed on the document table 15. The detecting sensor of the document discharge unit detects an angle of the document discharge unit 17 or an original document discharged to the document discharge unit 17. The discharge unit 18 includes a discharge unit sensor that detects the discharged product discharged to the discharge unit 18.

The image processing device 10 may communicate with the external terminal device 50 wirelessly or via wired connection. In this case, an information processing device may include the image processing device 10 and the external terminal device 50. The external terminal device 50 includes a display screen 51 that is alternative to the function of the user interface 13. The display screen 51 displays an operation screen and receives an operation performed by the user. Examples of the external terminal device 50 include a portable terminal (such as a smartphone and a tablet terminal) and a PC that are wirelessly connectable with the image processing device 10.

### Hardware Configuration of Image Processing Device

Next, a hardware configuration of the image processing device 10 according to the present exemplary embodiment will be described.

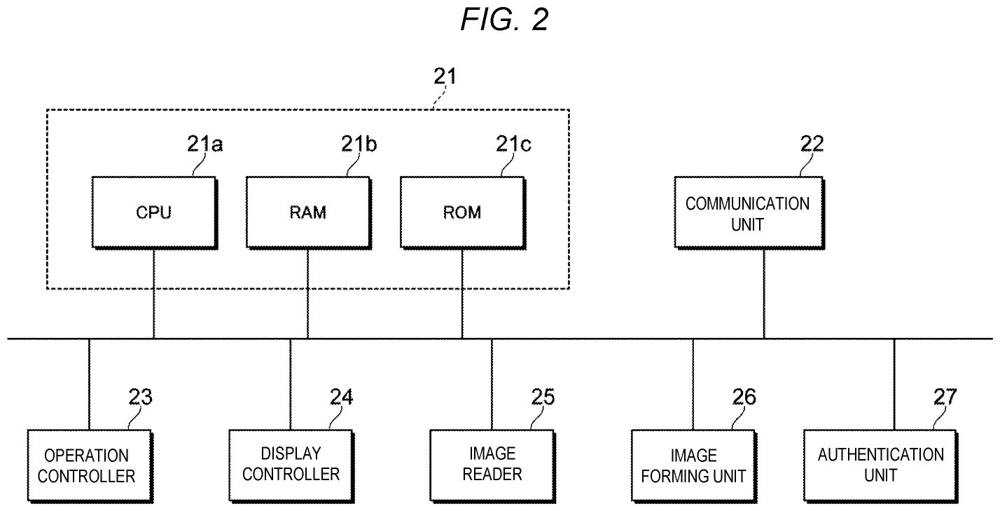

FIG. 2 is a block diagram illustrating an example of the hardware configuration of the image processing device 10 according to the present exemplary embodiment.

As illustrated in FIG. 2, the image processing device 10 according to the present exemplary embodiment includes a controller 21, a communication unit 22, an operation controller 23, a display controller 24, an image reader 25, an image forming unit 26, and an authentication unit 27.

The controller 21 controls operations of the respective units of the image processing device 10. The controller 21 includes a central processing unit (CPU) 21a, a random access memory (RAM) 21b, and a read only memory (ROM) 21c.

The CPU 21a is an example of a processor. The CPU 21a reads a program stored in the ROM 21c, and executes the program using the RAM 21b as a work area, to thereby implement various functions of the image processing device 10. The RAM 21b is a memory that is used as a working memory for the CPU 21a. The ROM 21c is a memory that stores various programs to be executed by the CPU 21a.

Here, the program to be executed by the CPU 21a may be provided to the controller 21 in a state of being stored in a computer-readable recording medium such as a magnetic recording medium (for example, a magnetic tape or a magnetic disk), an optical recording medium (for example, an optical disc), an optical magnetic recording medium or a semiconductor memory.

The programs to be executed by the CPU 21a may be downloaded to the controller 21 using a communication tool such as the Internet.

In the embodiment, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment, the term “processor” is broad enough to encompass one processor or plural processors in collaboration which are located physically apart from each other but may work cooperatively. The order of operations of the processor is not limited to one described in the embodiments above, and may be changed.

The communication unit 22 is a communication interface connected to a wireless or wired communication line. The communication unit 22 communicates with the external terminal device 50 over the communication line.

The operation controller 23 inputs information to the controller 21, in accordance with the operation performed by the user. In this example, the operation controller 23 is implemented by the user interface 13 functioning as the touch panel.

Furthermore, the display controller 24 displays various information to the user. In this example, the display controller 24 is implemented by the display 130 provided in the user interface 13.

The image reader 25 is an example of an image reader. The image reader 25 reads an image of the original document in accordance with an instruction by a user, and generates image data representing the read image. In this example, the image reader 25 is implemented by the scanner 11.

The image forming unit 26 is an example of an image forming unit. The image forming unit 26 forms an image on a recording material (such as a sheet) in accordance with image data. In this example, the image forming unit 26 is implemented by the printer 12. The image forming unit 26 may form an image using an electrophotographic process, or may form an image using another process.

The authentication unit 27 authenticates the user when the user attempts to operate the image processing device 10. For example, the authentication unit 27 specifies the user in response to the user holding an integrated circuit (IC) card (such as an employee ID card of the user) over an IC card reader (not illustrated) of the image processing device 10, and authenticates the user. In this case, the authentication unit 27 is implemented by the card reader. Alternatively, the authentication unit 27 may authenticates the user in response to, for example, the user inputting at least one of (i) an ID of the user or (ii) a password of the user to the user interface 13.

### Functional Configuration of Controller

Next, a functional configuration of the controller 21 will be described.

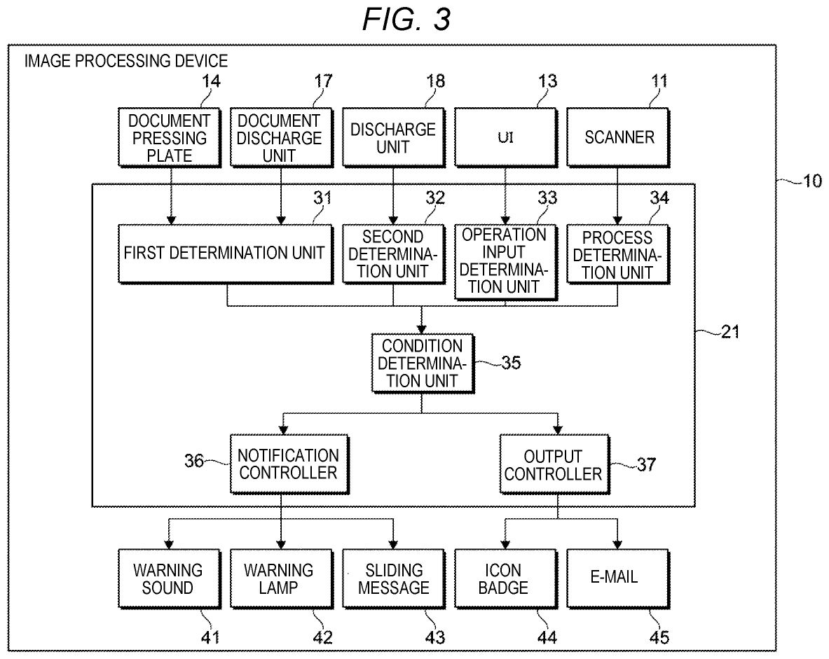

FIG. 3 is a block diagram illustrating an example of a functional configuration of the controller 21. The controller 21 includes a first determination unit 31, a second determination unit 32, an operation input determination unit 33, a process determination unit 34, a condition determination unit 35, a notification controller 36, and an output controller 37.

The first determination unit 31 determines whether the original document is left, based on in accordance with whether an operation of opening and closing the platen cover 14 was performed after a process of reading the original document. The first determination unit 31 determines whether the original document is left on the document discharge unit 17 after the document reading operation was performed using the document feeder 16.

The second determination unit 32 determines whether a discharged product, which is a printed sheet, is left on the discharge unit 18.

Here, an operation of removing an original document on the document table 15, an operation of removing an original document on the document discharge unit 17, and an operation of removing a discharged product on the discharge unit 18 are examples of an operation regarding removal of a medium.

The operation input determination unit 33 determines whether a user operation is performed on the operation screen displayed on the display 130 serving as the user interface 13. This “user operation” is an example of predetermined, another operation excluding the operation regarding the removal of the medium.

The process determination unit 34 determines whether the document reading operation is performed using the document feeder 16. The process determination unit 34 also determines whether the document reading operation is performed using the document table 15 and whether a printing operation is performed using the printer 12. These “operations” are examples of predetermined, another operation excluding the operation regarding the removal of the medium.

The condition determination unit 35 determines a mode in which the user is alerted when it is determined that (i) it is forgotten to take the medium or (ii) there is a possibility that it is forgotten to take the medium, based on whether predetermined, another operation excluding the operation regarding the removal of the medium is performed.

The notification controller 36 is as an example of a notification unit. The notification controller 36 notifies the user that it is forgotten to take the medium from the image processing device 10. More specifically, the notification controller 36 notifies the user that it is forgotten to take the original document left on the document table 15 of the image processing device 10 or that it is forgotten to take the original documents left on the document discharge unit 17 of the image processing device 10. For example, the notification controller 36 performs a notification using warning sound 41 by the sound body, a warning lamp 42 by an LED device, and a sliding message 43 displayed on the display 130, so as to convey details of warning. The warning sounds 41, the warning lamp 42 and the sliding message 43 may be combined to notify the user of the warning.

The notification controller 36 may also notify the user that it is forgotten to take the discharged product left on the discharge unit 18.

The output controller 37 is an example of an output unit. The output controller 37 outputs unchecked information that is a notification to the user indicating that there are contents to be newly checked. Examples of the phrase “contents to be newly checked” include contents indicating a state in which a disadvantage occurs when the user moves away from the image processing device 10. More specifically, examples of the phrase “contents to be newly checked” include (i) contents indicating that it is forgotten to take the medium (such as the original document or the discharged printed sheet) and (ii) contents indicating there is a possibility that it is forgotten to take the medium. Examples of the term “unchecked information” include an icon badge 44 output on the display 130. The icon badge 44 indicates that the user operation on the operation screen can continue. The icon badge 44 is output to overlap at least one of (i) an icon that is an operation button to start a program or (ii) management information on the image processing device 10. The icon badge 44 may be smaller than at least one of (i) the icon which the icon badge 44 is displayed to overlap or (ii) the management information which the icon badge 44 is displayed to overlap. The unchecked information may be output on a region that is located on the display 130 but does not overlap any of the icons.

Furthermore, the output controller 37 may transmit notification information to the user or an administrator of the image processing device 10. Examples of the notification information include an e-mail 45.

The respective functional units constituting the controller 21 illustrated in FIG. 3 are implemented by cooperation of software resources and hardware resources. Specifically, when the image processing device 10 is implemented by the hardware configuration illustrated in FIG. 2, an OS program and application programs stored in ROM 21c are loaded onto the RAM 21b and executed by the CPU 21a, to thereby implement the functional units including the first determination unit 31, the second determination unit 32, the operation input determination unit 33, the process determination unit 34, the condition determination unit 35, the notification controller 36, and the output controller 37.

Process for Case in which it is Forgotten to Take Original Document

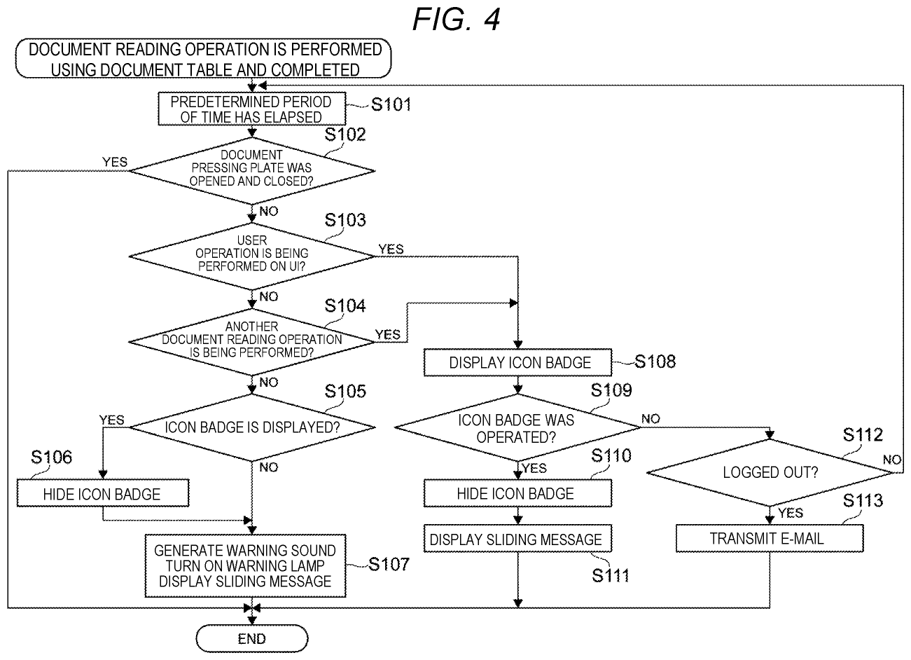

As an example of forgetting to take a medium, a process for a case in which it is forgotten to take an original document will be described with reference to FIG. 4.

FIG. 4 is a flowchart of a processing procedure for performing a notification or an output about forgetting to take the original document. Here, it is assumed that the original document is still left on the document table 15 after a predetermined period of time has elapsed since the document reading operation was performed using the document table 15 and completed.

First, after the predetermined period of time has elapsed since the document reading operation was performed using the document table 15 and completed (step 101), the first determination unit 31 illustrated in FIG. 3 determines whether the platen cover 14 was opened and closed (step 102). If the platen cover 14 was opened and closed (Yes in step 102), the first determination unit 31 determines that the original document has been removed and ends the process. If the platen cover 14 was not opened or closed (No in step 102), the first determination unit 31 determines that (i) it is forgotten to take the original document or (ii) there is a possibility that it is forgotten to take the original document, and proceeds to a next step.

Then, the operation input determination unit 33 determines whether the user operation is being performed on the user interface 13 (step 103). When a user operation is being performed on the user Interface 13 (Yes in step 103), the output controller 37 outputs the icon badge 44 to the display 130 as unchecked information that is the notification to the user indicating that there are contents to be newly confirmed (step 108). The operation input determination unit 33 determines whether the user operated the icon badge 44 (step 109). If it is determined that the user operated the icon badge 44 (Yes in step 109), the icon badge 44 is hidden (step 110), and then the sliding message 43 is displayed on the display 130 (step 111). The sliding message 43 is an example of check information indicating that it is forgotten to take the original document. The sliding message 43 is displayed using text in a larger region than the icon badge 44, so as to further alert the user. The displaying of the sliding message 43 is regarded as well notifying the user that it is forgotten to take the document, and the process ends.

If it is determined in step 109 that the user has not operated the icon badge 44 (No in step 109), it is determined whether the user has logged out (step 112). If it is determined that the user has logged out (Yes in step 112), the condition determination unit 35 determines that it is forgotten to take the original document, and the output controller 37 transmits the e-mail 45 to the external terminal device 50 of the user (step 113). If it is determined that the user has not logged out (No in step 112), the procedure returns to step 101 and repeats the processes for the case in which it is forgotten to take the original document.

If it is determined in step 103 that no user operation is not being performed on the user interface 13 (No in step 103), the process determination unit 34 determines whether another document reading operation is being performed (step 104). If another document reading operation is being performed (Yes in step 104), the procedure proceeds to the processes at step 108 and subsequent steps. If no other document reading operation is being performed (No in step 104), the condition determination unit 35 determines whether the icon badge 44 is displayed on the display 130 (step 105). If the icon badge 44 is not displayed (No in step 105), it is determined that (i) it is forgotten to take the original document or (ii) there is a possibility that it is forgotten to take the original document, and the notification controller 36 notifies the user that it is forgotten to take the original document by generating the warning sound 41, turning on the warning lamp 42, and displaying the sliding message 43 (step 107). Then, the procedure ends.

If it is determined in step 105 that the icon badge 44 is displayed (Yes in step 105), the icon badge 44 is hidden (step 106). Then, the notification in step 107 is performed, and the procedure ends.

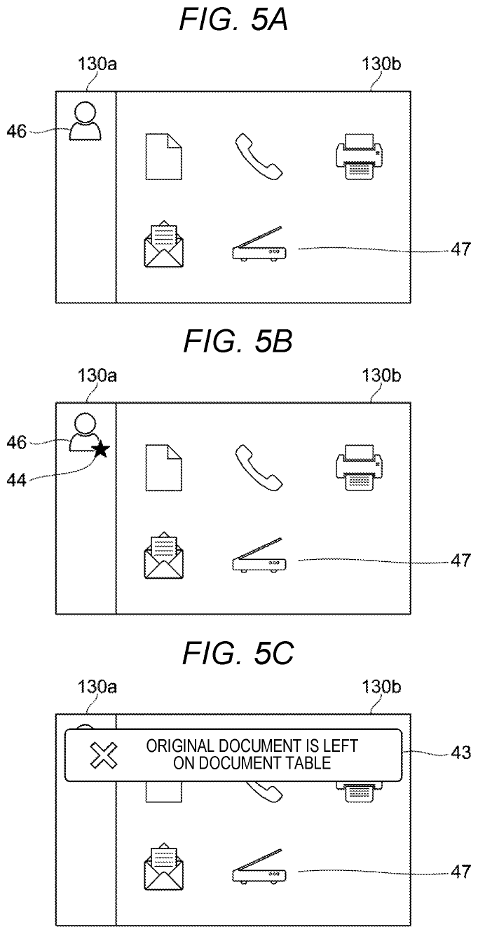

The displaying of the sliding message 43 and the icon badge 44 will be described. FIGS. 5A to 5C illustrate examples of an element added to an operation screen having a fixed screen and a menu screen. FIG. 5A illustrates an example of a layout of the fixed screen and the menus screen. FIG. 5B illustrates an example of the displaying of the icon badge 44. FIG. 5C illustrates an example of the displaying of the sliding message 43.

The operation screen displayed on the display 130 illustrated in FIG. 1 includes the fixed screen 130a and the menu screen 130b as illustrated in FIG. 5A. The fixed screen 130a is a screen that continues to be displayed when a preview is displayed during the document reading operation. Setting information of the image processing device 10 and a user icon 46 may be displayed on the fixed screen 130a. The user icon 46 is an icon with which the user is accessible to login user information. The menus screen 130b changes to a processing screen in response to the user operating any of various icons 47 relating to image processing. Also, a layout of the icons 47 may be changed in accordance with the operation performed by the user.

As illustrated in FIG. 5B, the icon badge 44 is displayed on the fixed screen 130a, to overlap the user icon 46. With this configuration, even when the user is operating the menu screen 130b, the icon badge 44 continues to be displayed, so that the icon badge 44 clearly notifies the user who has logged-in that there are contents to be newly checked.

As illustrated in FIG. 5C, the sliding message 43 is displayed larger than the user icon 46 displayed on the fixed screen 130a and the icons 47 displayed on the menu screen 130b.

In the present exemplary embodiment, the sliding message 43 (an example of the check information that notifies the user of specific contents) is displayed using text in a larger region than the icon badge 44 (an example of the unchecked information that alerts the user). Displaying the sliding message 43 using text in the large region reduces a chance that the user overlooks the sliding message 43.

In the example illustrated in FIGS. 5A to 5C, the operation screen includes the fixed screen 130a and the menu screen 130b. It is noted that the present disclosure is applicable to an operation screen including no fixed screen 130a.

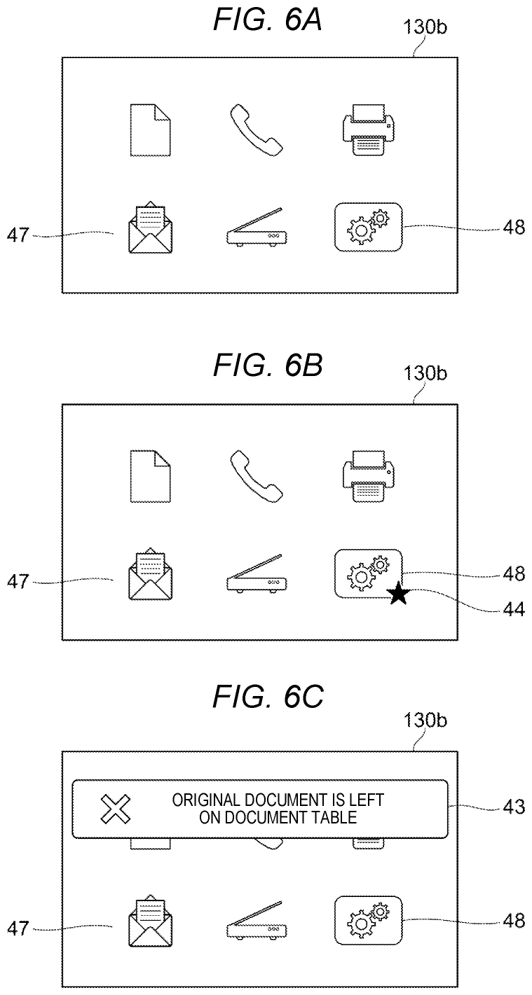

FIGS. 6A to 6C illustrate examples of an element added to an operation screen having no fixed screen. FIG. 6A illustrates an example of the menus screen. FIG. 6B illustrates an example of displaying of the icon badge 44. FIG. 6C illustrates an example of displaying of the sliding message 43.

When the screen 130b is displayed on the operation screen but the fixed screen 130a (illustrated in FIGS. 5A to 5C) is not displayed, management information (such as the user icon 46 displayed on the fixed screen 130a of FIGS. 5A to 5C) may be displayed on the menu screen 130b.

In FIG. 6A, in addition to the icons 47 relating to the image processing, the user icon 46 and a setting icon 48 (which are examples of the management information) are displayed on the menus screen 130b. The setting icon 48 allows the user to access device settings and specification settings of the image processing device 10.

As illustrated in FIG. 6B, the icon badge 44 is displayed to overlap any of the icons. The icon badge 44 may be displayed to overlap the user icon 46 or the setting icon 48. Accordingly, even when an operation regarding an image reading process, a copying process or the like is being performed on the menu screen 130b, the icon badge 44 continues to be displayed.

As illustrated in FIG. 6C, the sliding message 43 is displayed larger than any of the icons 47 and the setting icon 48, and in front of the icons 47 and the setting icon 48.

As described above, in the present exemplary embodiment, a mode of at least one of (i) the notification by the notification unit or (ii) the output by the output unit changes in accordance with whether the user operated the user interface 13. For example, whether the sliding message 43 (an example of the check information) or the icon badge 44 (an example of the unchecked information) is displayed on the operation screen is determined based on whether the user operated the user interface 13.

Process for Case in which it is Forgotten to Take Discharged Product

Forgetting to take a discharged product is an example of forgetting to take a medium.

In FIG. 4, the user is alerted to the fact that it is forgotten to take the original document, based on the determination made by first determination unit 31. Alternatively, the user may be alerted to a fact that it is forgotten to take a discharged product. If the user operation is performed on the UI after the second determination unit 32 illustrated in FIG. 3 determines that the discharged product is left on the discharge unit 18, the second determination unit 32 may determine that it is forgotten to take the discharged product and alert the user to the fact that it is forgotten to take the discharged printed sheet. In this case, an element may be added to the operation screen in a similar manner to the case in which it is forgotten to take the original document as described above.

### Notification to External Terminal Device 50

Furthermore, in the above-described examples, the notification about forgetting to take a medium is displayed on the display 130 which is provided in the image processing device 10 as the user interface 13. It is noted that the present disclosure is not limited to this configuration.

For example, the external terminal device 50 (such as a smartphone or a tablet) may be used as the user interface 13 of the image processing device 10. The external terminal device 50 serves as a computer device that instructs the image processing device 10 to perform image processing. The external terminal device 50 includes a CPU that is an example of a processor serving as a general-purpose information processing device. The display screen 51 (such as a touch panel) of the external terminal device 50 serves as an alternative to the user interface 13. The display screen 51 may display the operation screens illustrated in FIGS. 5 and 6. Furthermore, upon the external terminal device 50 receiving information about forgetting to take the original document, the display screen 51 displays the sliding message 43 and/or the icon badge 44. In place of giving a warning using the display screen 51, it is also possible to adopt generation of warning sound using a buzzer of the external terminal device 50 or turning on of a warning lamp using an LED of the external terminal device 50.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image processing device comprising:
a notification unit configured to notify a user that it is forgotten to take a medium from the image processing device; and
an output unit configured to, if (a)(i) it is forgotten to take the medium or (ii) there is a possibility that it is forgotten to take the medium and (b) predetermined, another operation excluding an operation relating to removal of the medium is performed, output unchecked information that is a notification to the user indicating that there are contents to be newly checked.

2. The image processing device according to claim 1, further comprising:
a display configured to display at least one of (i) an operation button to be operated by the user or (ii) management information on the image processing device, wherein the unchecked information is output to overlap at least one of the operation button or the management information.

3. The image processing device according to claim 2, wherein the unchecked information is displayed smaller than a size of the at least one of the operation button or the management information which the unchecked information overlaps.

4. The image processing device according to claim 2, wherein in response to the user operating the unchecked information, check information indicating that it is forgotten to take the medium is displayed on the display.

5. The image processing device according to claim 4, wherein the check information is displayed using text in a larger region than the unchecked information.

6. The image processing device according to claim 2, wherein if the user has not operated the unchecked information, notification information is transmitted to the user or an administrator of the image processing device.

7. The image processing device according to claim 1, further comprising:
a document table on which an original document to be read is to be placed; and
a discharge unit configured to discharge a discharged product, wherein
the operation relating to the removal of the medium comprises at least one of (i) an operation of removing the original document placed on the document table or (ii) an operation of removing the discharged product on the discharge unit.

8. The image processing device according to claim 7, further comprising:
a display configured to display at least one of (i) an operation button to be operated by the user or (ii) management information on the image processing device, wherein
the predetermined other operation comprises (i) an operation performed on a document feeder configured to feed the original document to the document table or (ii) an operation performed by the user on the display.

9. The image processing device according to claim 1, further comprising:
a display configured to display at least one of (i) an operation button to be operated by the user or (ii) management information on the image processing device, wherein
a mode of at least one of the notification by the notification unit or the output by the output unit changes in accordance with whether the user operated the display.

10. The image processing device according to claim 9, wherein in response to the user operating the display, the unchecked information is displayed so as not to overlap the operation button displayed on the display.

11. An information processing device for enabling a user to operate an image processing device for processing an image, the information processing device comprising:
a processor configured to:
perform control so as to notify the user that it is forgotten to take a medium from the image processing device; and
if (a)(i) it is forgotten to take the medium or (ii) there is a possibility that it is forgotten to take the medium and (b) predetermined, another operation excluding an operation relating to removal of the medium was performed, perform control so as to output unchecked information that is a notification to the user indicating that there are contents to be newly checked.

12. An image processing device comprising:
notification means for notifying a user that it is forgotten to take a medium from the image processing device; and
output means for, if (a)(i) it is forgotten to take the medium or (ii) there is a possibility that it is forgotten to take the medium and (b) predetermined, another operation excluding an operation relating to removal of the medium is performed, outputting unchecked information that is a notification to the user indicating that there are contents to be newly checked.
